(19) United States
(12) Patent Application Publication
(10) Pub. No.: US 2012/0112729 A1
(43) Pub. Date: May 10, 2012

(54) IN-RUSH LIMITER CIRCUIT FOR A DRIVER MODULE

(75) Inventors: Daniel Robert Edwards, Ypsilanti, MI (US); Viren B. Merchant, Canton, MI (US); Harold Ryan Macks, Redford, MI (US)

(73) Assignee: VISTEON GLOBAL TECHNOLOGIES, INC., Van Buren Twp., MI (US)

(21) Appl. No.: 12/941,560

(22) Filed: Nov. 8, 2010

(51) Int. Cl. G05F 3/08

(52) U.S. Cl. 323/312

(57) ABSTRACT

A limiter circuit includes a voltage rail having an input and an output, the input receiving an applied input voltage, a switching device in electrical communication with the voltage rail to selective control an electric current flowing through the output of the voltage rail, limiter capacitor in electrical communication with the input of the voltage rail and the switching device, wherein the limiter capacitor and the switching device are in parallel electrical communication between the input and an electrical ground, and a first resistor interposed between the limiter capacitor and the electrical ground, wherein an impedance of the resistor and the limiter capacitor define a time constant for the charging the limiter capacitor, and wherein the time constant of the limiter capacitor controls a voltage applied to the switching device and a current flowing through the output of the voltage rail.

### FIELD OF THE INVENTION

The invention relates to an electrical circuit. More particularly, the invention is directed to an in-rush limiter circuit for a driver module and a method of limiting in-rush current.

### BACKGROUND OF THE INVENTION

Driver module circuits for controlling light emitting diodes typically include input capacitors. The input capacitors require a charging current, called in-rush, that exceeds a steady state operating current of the driver module. Accordingly, the in-rush current required for charging the input capacitors can damage the upstream driving module.

It would be desirable to have a cost efficient limiter circuit for a driver module, wherein the limiter circuit controls an output current (i.e. in-rush current) to limit a rate of current change to protect the upstream driver module.

### SUMMARY OF THE INVENTION

Concordant and consistent with the present invention, a cost efficient limiter circuit for a driver module, wherein the limiter circuit controls an output current (i.e. in-rush current) to limit a rate of current change to protect the upstream driver module, has surprisingly been discovered.

In one embodiment, a limiter circuit comprises: a voltage rail having an input and an output, the input receiving an applied input voltage; a switching device in electrical communication with the voltage rail to selective control an electric current flowing through the output of the voltage rail; a limiter capacitor in electrical communication with the input of the voltage rail and the switching device, wherein the limiter capacitor and the switching device are in parallel electrical communication between the input and an electrical ground; and a first resistor interposed between the limiter capacitor and the electrical ground, wherein an impedance of the resistor and the limiter capacitor define a time constant for the charging the limiter capacitor, and wherein the time constant of the limiter capacitor controls a voltage applied to the switching device and a current flowing through the output of the voltage rail.

In another embodiment, an electrical circuit comprises: an input for receiving an applied input voltage; a transistor having a gate, a source, and a drain, the source in electrical communication with the input; a limiter capacitor in electrical communication with the input and the gate of the transistor, wherein the capacitor and the transistor are in parallel electrical communication between the input and an electrical ground; a first resistor interposed between the capacitor and the electrical ground, wherein an impedance of the resistor and the capacitor define a time constant for the charging and discharging of the capacitor, and wherein the time constant of the capacitor controls a voltage applied to the gate of the transistor and a current flowing between the source of the transistor and the drain of the transistor; and a driver module having an input capacitor in electrical communication with the drain of the transistor to receive an electric current therefrom.

The invention also includes methods for limiting an electric current.

One method comprises the steps of: providing a limiter circuit comprising: a voltage rail having an input and an output; a switching device in electrical communication with the voltage rail to selective control an electric current flowing through the output of the voltage rail; a limiter capacitor in electrical communication with the input of the voltage rail and the switching device, wherein the limiter capacitor and the switching device are in parallel electrical communication between the input and an electrical ground; and a first resistor interposed between the limiter capacitor and the electrical ground, wherein an impedance of the resistor and the limiter capacitor define a time constant for the charging the limiter capacitor; and applying a voltage to the input of the voltage rail, wherein the limiter capacitor charges and a voltage across the limiter capacitor increases based upon the time constant, and wherein the voltage across the capacitor is applied to the switching device to control the electric current flowing through the output of the voltage rail.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic representation of an electrical circuit according to an embodiment of the present invention;

FIG. 2 is a schematic diagram of a limiter circuit of the electrical circuit of FIG. 1;

FIG. 3 is a schematic flow diagram of a method for using the electrical circuit of FIG. 1 according to an embodiment of the present invention;

FIG. 4 is a graphical plot of a voltage waveform and a current waveform representing the operation of the electrical circuit of FIG. 1; and

FIG. 5 is a schematic flow diagram of a method for using the electrical circuit of FIG. 1 according to another embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

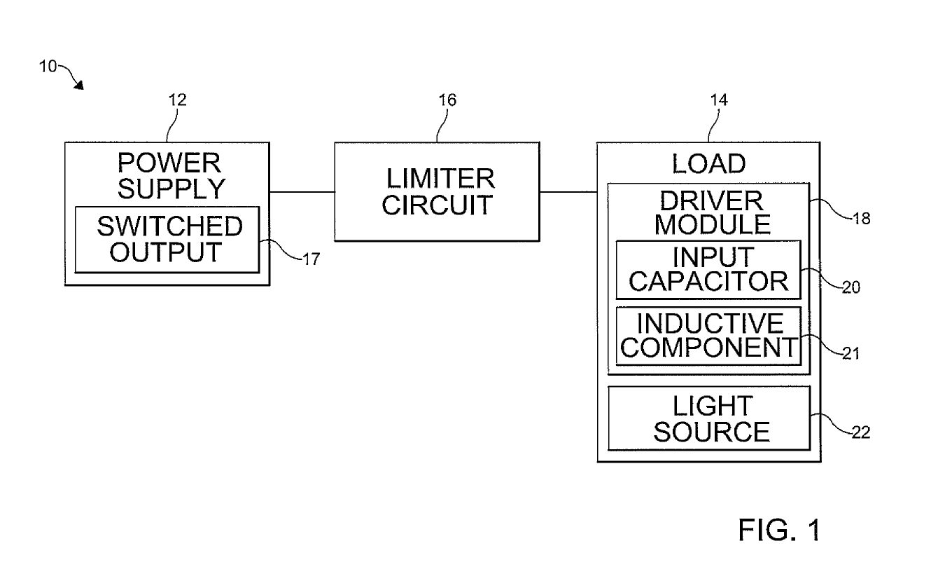

FIG. 1 illustrates an electrical system 10 according to an embodiment of the present invention. As shown, the electrical system 10 includes a power supply 12 in electrical communication with a load 14 and an in-rush limiter circuit 16 electrically interposed between the power supply 12 and the load 14. However, it is understood that the electrical system 10 may include additional components, as desired. It is further understood that the electrical system 10 may be in communication with other components, systems, loads and power supplies, as desired.

The power supply 12 is typically a direct current (DC) source of electrical energy such as a battery, for example. However, it is understood that other sources of electrical energy can be used. It is further understood that the power supply 12 can be configured to provide a pre-determined voltage across the load 14. In certain embodiments, the power supply 12 includes a switched output 17 as appreciated by one skilled in the art. As a non-limiting example, the switched output 17 of the power supply 12 can be toggled between three states, namely, an “ON” state, an “OFF—0.0V” state, and an “OFF—open circuit” state. However, any number states can be included.

The load 14 typically includes a driver module (e.g. LED drive module (LDM)) 18 having at least one input capacitor 20 and at least one inductive component 21. As a non-limiting example, the driver module 18 is in electrical communication with a light source 22 such as a light emitting diode to control a selective illumination of the light source 22. However, it is understood that the driver module 18 can be configured to control any light source. It is further understood that the load 14 may be any device, component, or system configured to be electrically energized by the power supply 12.

The limiter circuit 16 is in electrical communication with the power supply 12 and the load 14 and configured to receive an applied voltage from the power supply 12 and regulate and transmit an electric current to the load 14.

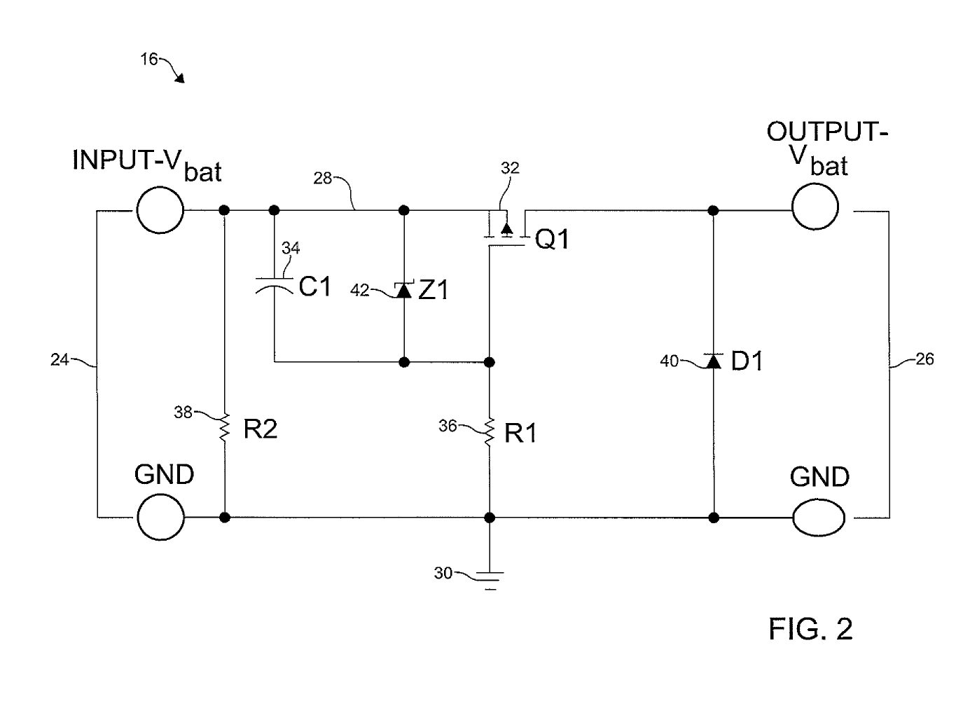

As more clearly shown in FIG. 2, the limiter circuit 16 includes an input 24 in electrical communication with the power supply 12, an output 26 sharing a voltage rail 28 and an electrical ground 30 with the input 24, a switching device 32 in electrical communication with the input 24 and the output 26 to control a current flowing through the voltage rail 28, a limiter capacitor 34 in electrical communication with the switching device 32 to control a switching state of the switching device 32, and a first resistor 36 interposed between the limiter capacitor 34 and the electrical ground 30. However, it is understood that the limiter circuit 16 may include additional components and systems, as desired. It is further understood that the limiter circuit 16 may be in electrical communication with other circuits, systems and components, as desired.

The input 24 is in electrical communication with the power supply 12 to receive an applied voltage from the power supply 12. It is understood that the input 24 can be in electrical communication with any source of electrical energy. It is further understood that the input 24 can include any protection circuitry and the like.

The output 26 is electrically coupled to the load 14 to transmit an electric current to the load 14. As shown, the output 26 is in electrical communication with the input 24, wherein the switching device 32 is disposed therebetween to control the flow of current between the input 24 and the output 26. It is understood that additional components may be in electrical communication with the output 26, as desired. In certain embodiments, the output 26 is in electrical communication with the input 24 by the shared voltage rail 28 and the electrical ground 30, wherein the load 14 is electrically coupled to the output 26 to receive an electric current from the power supply 12. However, other electrical configurations can be used. For example, the input 24 and the output 26 can have independent connections to the electrical ground 30.

The switching device 32 is typically a field-effect transistor. In the embodiment shown, the switching device 32 is a MOSFET (Metal Oxide Semiconductor Field Effect Transistor) having a gate, a source, and a drain as known to someone skilled in the art of transistors. However, it is understood that other transistors or switches may be used to regulate the flow of current in the limiter circuit 16, as desired. In the embodiment shown, the source of the switching device 32 is in electrical communication with the input 24 and the drain is in electrical communication with an output 26 of the limiter circuit 16. The gate of the switching device 32 is in electrical communication with the limiter capacitor 34, wherein the limiter capacitor 34 and the switching device 32 are in parallel electrical communication between the input 24 and the electrical ground 30. As a non-limiting example, the switching device 32 has a cut-off voltage, as appreciated by one skilled in the art. It is understood when a voltage applied to the gate (V_{gs}) of the switching device 32 exceeds the cut-off voltage, the switching device 32 turns “ON” and electric current begins to flow from the source to the drain of the switching device 32. It is further understood that any switching device having any pre-determined cut-off voltage can be used.

The first resistor 36 is interposed between the limiter capacitor 34 and the electrical ground 30, wherein an impedance of the first resistor 36 and the limiter capacitor 34 define a time constant for the charging of the limiter capacitor 34. Accordingly, the time constant of the limiter capacitor 34 controls the voltage applied to the gate (V_{gs}) of the switching device 32 and thereby a current flowing between the source and the drain of the switching device 32.

In certain embodiments, the limiter circuit 16 includes a second resistor 38 disposed in parallel electrical configuration with the limiter capacitor 34. As a non-limiting example, the second resistor 38 is electrically coupled between the voltage rail 28 and the electrical ground 30 to provide a controlled means for discharging the limiter capacitor 34 when a voltage is not applied to the voltage rail 28 from the power supply 12.

In certain embodiments, the limiter circuit 16 includes a diode 40 electrical coupled between the voltage rail 28 and the electrical ground 30. As a non-limiting example, the diode 40 is in parallel electrical configuration with the input capacitor 20 of the driver module 18. As a further non-limiting example, the diode 40 is in electrical communication with the inductive component 21 of the driver module 18 to provide a ‘flyback’ path allowing an electric current to flow through the inductive component 21 of the driver module 18 until a magnetic field of the inductive component 21 collapses.

In certain embodiments, the limiter circuit 16 includes a Zener diode 42 electrically coupled between the voltage rail 28 and the electrical ground 30. As a non-limiting example, the Zener diode 42 is in parallel electrical configuration with the limiter capacitor 34 to selectively clamp a voltage across the limiter capacitor 34 as appreciated by one skilled in the art.

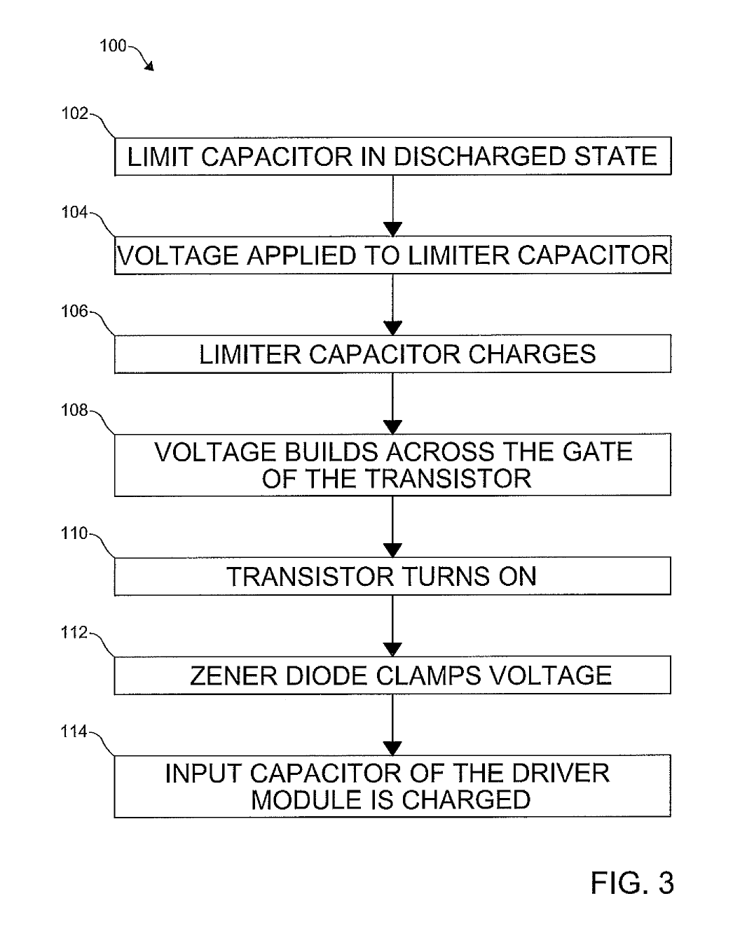

FIG. 3 illustrates a method 100 of using the electrical system 10 according to an embodiment of the present invention. In step 102, the power supply 12 holds the voltage rail 28 at approximately 0.0 V_{dc} (V_{bat}=0.0 V_{ac}) with respect to the electrical ground 30. In certain embodiments, the switched output 17 of the power supply 12 may be toggled to the “OFF—open circuit” state (i.e. high impendence). Accordingly, the limiter capacitor 34 is in a discharged state and the switching device 32 is “OFF”.

In step 104, the power supply 12 applies a voltage across the voltage rail 28 with respect to the electrical ground 30 (e.g. V_{bat} is toggled from 0.0V to “ON” state). In certain embodiments, the switched output 17 of the power supply 12 may be toggled from the “OFF—open circuit” state to the “ON” state. Accordingly, the limiter capacitor 34 is charged through the first resistor 36 to the electrical ground 30, as shown in step 106. It is understood that the time constant of the limiter capacitor 34 is a substantial factor in the charge-up rate of the limiter capacitor 34.

As the limiter capacitor 34 charges, a voltage builds across the gate (V_{gs}) of the switching device 32, as shown in step 108.

In step 110, the voltage at the gate (V_{gs}) of the switching device 32 continues to increase and a flow of current from the source to the drain increases until the cut-off voltage of the switching device 32 is exceeded and the switching device is in a full “ON” state (i.e. saturation).

As an electric current begins to flow to the output 26 from the drain of the switching device 32, the load 14 begins to receive the electric current. As a non-limiting example, the electric current flows from the output 26 to the driver module 18 and begins to charge the input capacitor(s) 20. It is understood that a flow of the electric current to the input capacitors 20 of the driver module 18 is limited by a controlled “turn ON curve” of the switching device 32. It is further understood that a controlled charging of the input capacitor(s) 20 of the driver module 18 regulates the in-rush current to suitable levels (e.g. charge up rates).

In step 112, once the switching device is in a full ON state, the voltage applied to the gate (V_{gs}) of the switching device 32 is also applied across the Zener diode 42. Accordingly, the Zener diode 42 is switched ON and limits (e.g. clamp) any further rise in the voltage at the gate (V_{gs}) of the switching device 32, thereby protecting the switching device 32 from an overvoltage condition.

In step 114, the input capacitors 20 of the driver module 18 are fully charged and the switching device 32 is fully turned ON. It is understood that the current flow to the driver module 18 from the output 26 is limited by an ON resistance (R_{ds}) of the switching device 32.

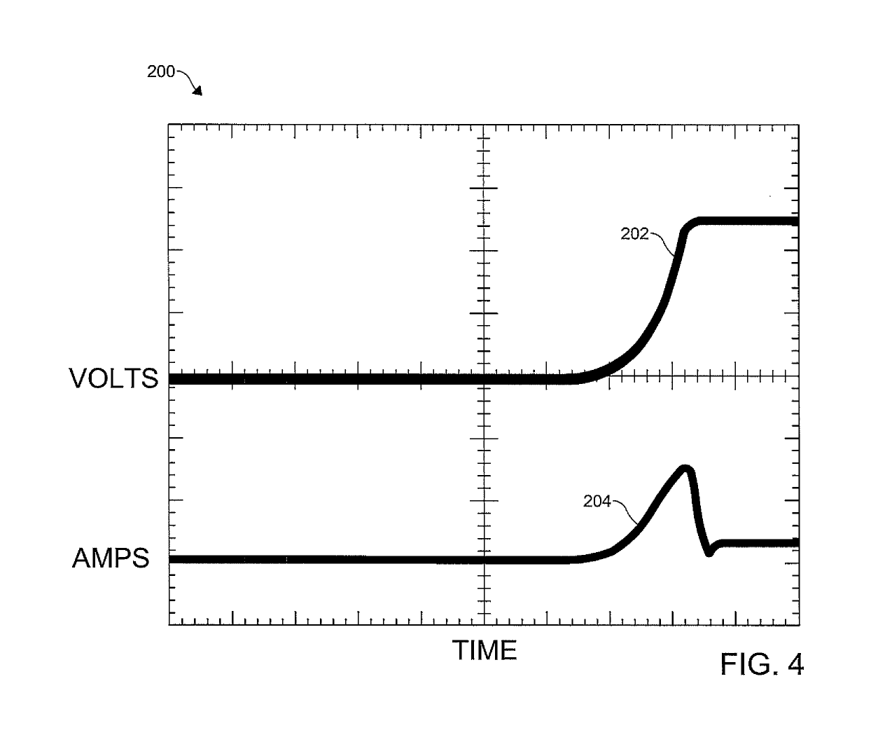

As an illustrative example, FIG. 4 shows a graphical plot of a voltage waveform 202 (i.e. Volts/time) taken across the limiter capacitor 34 of the limiter circuit 16 and an in-rush current waveform 204 (i.e. Amps/time) taken at the output 26 of the limiter circuit 16. As shown, the limiter capacitor 34 charges and a voltage increase based upon the time constant of the limiter capacitor 34. As the voltage across the limiter capacitor 34 increases, the voltage at the gate (V_{gs}) of switching device 34 increases. Accordingly, a current (e.g. in-rush current) at the output 26 is controlled based upon a time constant of the limiter capacitor 34. It is understood that the waveforms 202, 204 are for illustration of the regulation of an in-rush current using the limiter circuit 16 and should not be construed to limit the components of the limiter circuit 16 to values resulting in a similar waveform. It is further understood that other waveforms may result from the limiter circuit 16 according to the present invention.

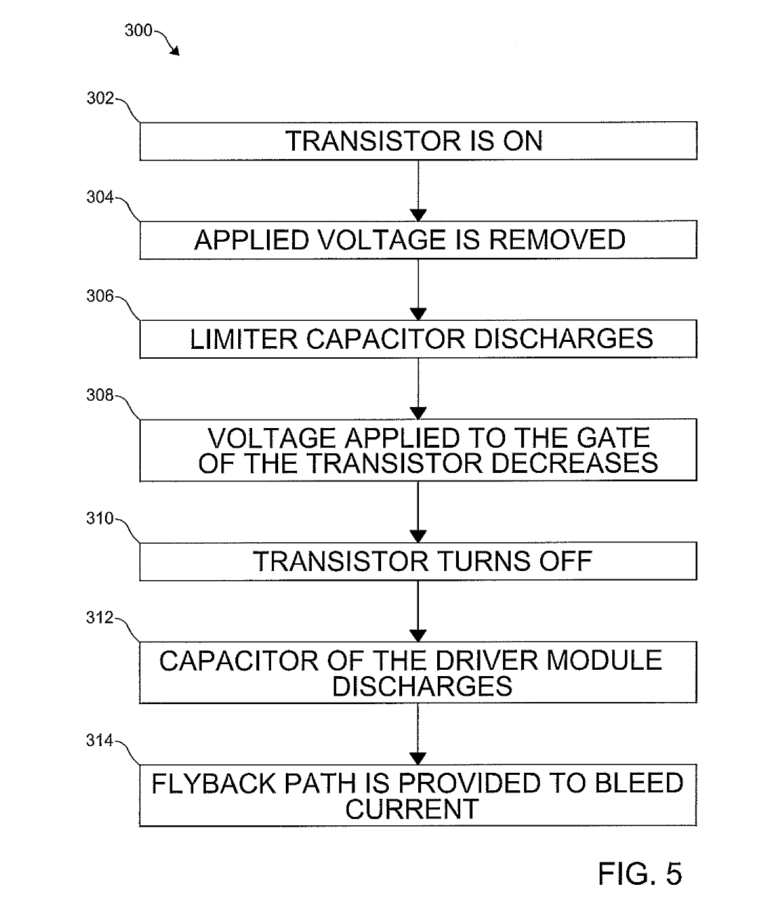

FIG. 5 illustrates a method 300 of using the electrical system 10 according to an embodiment of the present invention. Initially, the power supply 12 applies a voltage across the voltage rail 28 (i.e. V_{bat}=ON/high voltage) with respect to the electrical ground 30. In step 302, the limiter capacitor 34 is in a charged a charged state and the switching device 32 is in a full “ON” state (i.e. saturation).

In step 304 the voltage applied to the voltage rail 28 by the power supply is set to substantially zero (i.e. Vbat goes LOW (OFF)). In certain embodiments, the switched output 17 of the power supply 12 may be toggled to the “OFF—open circuit” state. Accordingly, the limiter capacitor 34 begins to discharge through a path including at least one of the first resistor 36 and the second resistor 38, as shown in step 306.

In step 308, as the limiter capacitor discharges, a voltage applied to the gate (V_{gs}) of the switching device 32 decreases toward the cut-off voltage of the switching device 32.

In step 310, the voltage at the gate (V_{gs}) of the switching device 32 falls below the cut-off voltage of the switching device 32 and the switching device 32 turns OFF. It is understood when the switching device 32 is turned OFF, current no longer flows from the drain of the switching device through the output 26 to the drive module 18. It is further understood that the second resistor 38 provides an electric current path for the limiter capacitor 16 to continue to discharge after the switching device 32 turns OFF.

In step 312, the input capacitors 20 of the driver module 18 discharge and the driver module 18 is turned OFF.

In step 314, the diode 40 provides a ‘flyback’ path to allow a current to flow through the inductive component 21 of the driver module 18 until a magnetic field generated by a circulating current of the inductive component 21 collapses.

The limiter circuit 16 of the present invention is configured to control an electric current (e.g. in-rush current) transmitted to the load 14. Specifically, the limiter circuit 16 can be used to selectively charge the input capacitors 20 of a driver module 18 during an initial “power on” sequence so that the inrush current does not exceed the design limits of the upstream driver module 32.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A limiter circuit comprising:
a voltage rail having an input and an output, the input receiving an applied input voltage;
a switching device in electrical communication with the voltage rail to selective control an electric current flowing through the output of the voltage rail;
a limiter capacitor in electrical communication with the input of the voltage rail and the switching device, wherein the limiter capacitor and the switching device are in parallel electrical communication between the input and an electrical ground; and
a first resistor interposed between the limiter capacitor and the electrical ground, wherein an impedance of the resistor and the limiter capacitor define a time constant for the charging the limiter capacitor, and wherein the time constant of the limiter capacitor controls a voltage applied to the switching device and a current flowing through the output of the voltage rail.

2. The limiter circuit according to claim 1, wherein the switching device is a field-effect transistor.

3. The limiter circuit according to claim 1, further comprising a load in electrical communication with the output of the voltage rail to selectively receive the electric current therefrom.

4. The limiter circuit according to claim 3, wherein the load includes an input capacitor in electrical communication with the output of the voltage rail to selectively receive an electric current from the output to charge the input capacitor.

5. The limiter circuit according to claim 3, further comprising a diode in electrical communication with an inductive component of the load to provide a flyback path allowing current to flow through the inductive component of the load until a magnetic field of the inductive component collapses.

6. The limiter circuit according to claim 1, further comprising a second resistor in electrical communication with the input of the voltage rail and the electrical ground, wherein the second resistor is in parallel electrical communication with the limiter capacitor to selectively discharge the limiter capacitor.

7. The limiter circuit according to claim 1, further comprising a Zener diode in electrical communication with the input of the voltage rail and the electrical ground, wherein the Zener diode is in parallel electrical communication with the limiter capacitor to selectively clamp a voltage across the limiter capacitor.

8. An electrical circuit comprising:
an input for receiving an applied input voltage;
a transistor having a gate, a source, and a drain, the source in electrical communication with the input;
a limiter capacitor in electrical communication with the input and the gate of the transistor, wherein the capacitor and the transistor are in parallel electrical communication between the input and an electrical ground;
a first resistor interposed between the capacitor and the electrical ground, wherein an impedance of the resistor and the capacitor define a time constant for the charging and discharging of the capacitor, and wherein the time constant of the capacitor controls a voltage applied to the gate of the transistor and a current flowing between the source of the transistor and the drain of the transistor; and
a driver module having an input capacitor in electrical communication with the drain of the transistor to receive an electric current therefrom.

9. The electrical circuit according to claim 8, wherein the transistor is a field-effect transistor.

10. The electrical circuit according to claim 8, wherein the driver module further comprises an inductive component in electrical communication with the input capacitor.

11. The electrical circuit according to claim 8, further comprising a diode in electrical communication with the inductive component of the driver module to provide a flyback path allowing current to flow through the inductive component of the driver module until a magnetic field of the inductive component collapses.

12. The electrical circuit according to claim 8, further comprising a second resistor in electrical communication with the input and the electrical ground, wherein the second resistor is in parallel electrical communication with the limiter capacitor to selectively discharge the limiter capacitor.

13. The electrical circuit according to claim 8, further comprising a Zener diode in parallel electrical communication with the limiter capacitor to selectively clamp a voltage across the limiter capacitor.

14. A method for limiting an electric current, the method comprising the steps of:
providing a limiter circuit comprising:
a voltage rail having an input and an output;
a switching device in electrical communication with the voltage rail to selective control an electric current flowing through the output of the voltage rail;
a limiter capacitor in electrical communication with the input of the voltage rail and the switching device, wherein the limiter capacitor and the switching device are in parallel electrical communication between the input and an electrical ground; and
a first resistor interposed between the limiter capacitor and the electrical ground, wherein an impedance of the resistor and the limiter capacitor define a time constant for the charging the limiter capacitor; and
applying a voltage to the input of the voltage rail, wherein the limiter capacitor charges and a voltage across the limiter capacitor increases based upon the time constant, and wherein the voltage across the capacitor is applied to the switching device to control the electric current flowing through the output of the voltage rail.

15. The method according to claim 14, wherein the switching device is a field-effect transistor.

16. The method according to claim 14, further comprising the step of providing a load in electrical communication with the output of the voltage rail to selectively receive the electric current therefrom.

17. The method according to claim 16, wherein the load includes an input capacitor in electrical communication with the output of the voltage rail to selectively receive an electric current from the output to charge the input capacitor.

18. The method according to claim 16, further comprising a diode in electrical communication with sn inductive component of the load to provide a flyback path allowing current to flow through the inductive component of the load until a magnetic field of the inductive component collapses.

19. The method according to claim 14, wherein the limiter circuit further comprises a second resistor in electrical communication with the input of the voltage rail and the electrical ground, wherein the second resistor is in parallel electrical communication with the limiter capacitor to selectively discharge the limiter capacitor.

20. The method according to claim 14, wherein the limiter circuit further comprises a Zener diode in electrical communication with the input of the voltage rail and the electrical ground, wherein the Zener diode is in parallel electrical communication with the limiter capacitor to selectively clamp a voltage across the limiter capacitor.
